(19) United States
(12) Patent Application Publication
(10) Pub. No.: US 2025/0389536 A1
(43) Pub. Date: Dec. 25, 2025

(54) Efficient Vision-Aided Inertial Navigation Using a Rolling-Shutter Camera with Inaccurate Timestamps

(71) Applicant: Regents of the University of Minnesota, Minneapolis, MN (US)

(72) Inventors: Stergios I. Roumeliotis, Los Altos Hills, CA (US); Chao Guo, Los Altos, MN (US)

(73) Assignee: Regents of the University of Minnesota, Minneapolis, MN (US)

(21) Appl. No.: 19/258,731

(22) Filed: Jul. 2, 2025

Related U.S. Application Data
(63) Continuation of application No. 18/363,593, filed on Aug. 1, 2023, now Pat. No. 12,379,215.
Application No. 18/363,593 is a continuation of application No. 16/025,574, filed on Jul. 2, 2018, now Pat. No. 11,719,542.
Application No. 16/025,574 is a continuation of application No. 14/733,468, filed on Jun. 8, 2015, now Pat. No. 10,012,504.
(60) Provisional application No. 62/014,532, filed on Jun. 19, 2014.

(51) Int. Cl. G01C 21/16; G06T 7/277

(52) U.S. Cl. CPC G01C 21/1656; G06T 7/277; G06T 2207/30241; G06T 2207/30244

(57) ABSTRACT

Vision-aided inertial navigation techniques are described. In one example, a vision-aided inertial navigation system (VINS) comprises an image source to produce image data at a first set of time instances along a trajectory within a three-dimensional (3D) environment, wherein the image data captures features within the 3D environment at each of the first time instances. An inertial measurement unit (IMU) to produce IMU data for the VINS along the trajectory at a second set of time instances that is misaligned with the first set of time instances, wherein the IMU data indicates a motion of the VINS along the trajectory. A processing unit comprising an estimator that processes the IMU data and the image data to compute state estimates for 3D poses of the IMU at each of the first set of time instances and 3D poses of the image source at each of the second set of time instances along the trajectory. The estimator computes each of the poses for the image source as a linear interpolation from a subset of the poses for the IMU along the trajectory.

This application is a continuation of U.S. patent application Ser. No. 18/363,593, filed on Aug. 1, 2023, which is a continuation of U.S. patent application Ser. No. 16/025,574, filed on Jul. 2, 2018 and issued on Aug. 8, 2023 as U.S. Pat. No. 11,719,542, which is a continuation of U.S. patent application Ser. No. 14/733,468, filed on Jun. 8, 2015 and issued on Jul. 3, 2018 as U.S. Pat. No. 10,012,504, which claims the benefit of U.S. Provisional Patent Application No. 62/014,532, filed Jun. 19, 2014, the entire contents of which are incorporated herein by reference.

### TECHNICAL FIELD

This disclosure relates to navigation and, more particularly, to vision-aided inertial navigation.

### BACKGROUND

In general, a Vision-aided Inertial Navigation System (VINS) fuses data from a camera and an Inertial Measurement Unit (IMU) to track the six-degrees-of-freedom (d.o.f.) position and orientation (pose) of a sensing platform. In this way, the VINS combines complementary sensing capabilities. For example, an IMU can accurately track dynamic motions over short time durations, while visual data can be used to estimate the pose displacement (up to scale) between consecutive views. For several reasons, VINS has gained popularity within the robotics community as a method to address GPS-denied navigation.

Among the methods employed for tracking the six-degrees-of-freedom (d.o.f.) position and orientation (pose) of a sensing platform within GPS-denied environments, vision-aided inertial navigation is one of the most prominent, primarily due to its high precision and low cost. During the past decade, VINS have been successfully applied to spacecraft, automotive, and personal localization, demonstrating real-time performance.

### SUMMARY

In general, this disclosure describes various techniques for use within a vision-aided inertial navigation system (VINS). More specifically, this disclosure presents a linear-complexity inertial navigation system for processing rolling-shutter camera measurements. To model the time offset of each camera row between the IMU measurements, an interpolation-based measurement model is disclosed herein, which considers both the time synchronization effect and the image read-out time. Furthermore, Observability-Constrained Extended Kalman filter (OC-EKF) is described for improving the estimation consistency and accuracy, based on the system's observability properties.

In order to develop a VINS operable on mobile devices, such as cell phones and tablets, one needs to consider two important issues, both due to the commercial-grade underlying hardware: (i) the unknown and varying time offset between the camera and IMU clocks, and (ii) the rolling-shutter effect caused by certain image sensors, such as typical CMOS sensors. Without appropriately modelling their effect and compensating for them online, the navigation accuracy will significantly degrade. In one example, a linear-complexity technique is introduced for fusing inertial measurements with time-misaligned, rolling-shutter images using a highly efficient and precise linear interpolation model.

As described herein, compared to alternative methods, the proposed approach achieves similar or better accuracy, while obtaining significant speed-up. The high accuracy of the proposed techniques is demonstrated through real-time, online experiments on a cellphone.

Further, the techniques may provide advantages over conventional techniques that attempt to use offline methods for calibrating a constant time offset between a camera or other image source and an IMU, or the readout time of a rolling-shutter camera. For example, the equipment required for offline calibration is not always available. Furthermore, since the time offset between the two clocks may jitter, the result of an offline calibration process may be of limited use.

The details of one or more embodiments of the invention are set forth in the accompanying drawings and the description below. Other features, objects, and advantages of the invention will be apparent from the description and drawings, and from the claims.

### BRIEF DESCRIPTION OF DRAWINGS

FIG. 1 is a block diagram illustrating a vision-aided inertial navigation system comprising an IMU and a camera.

FIG. 2 is a graph illustrating example time synchronization and rolling-shutter effects.

FIGS. 3A and 3B are graphs that illustrate an example cell phone's trajectory between poses.

FIGS. 4A and 4B are graphs plotting Monte-Carlo simulations comparing: (a) Position RMSE (b) Orientation root-mean square errors (RMSE), over 20 simulated runs.

FIGS. 5A and 5B are graphs illustrating experimental results. FIG. 5A illustrates experiment 1 and plots the trajectory of the cell phone estimated by the algorithms under consideration. FIG. 5B illustrates experiment 2 and plots the trajectory of the cell phone estimated online.

FIG. 6 is a graph illustrating a computational time comparison for the measurement compression QR, employed in the MSC-KF between the proposed measurement model and a conventional method.

FIG. 7 shows a detailed example of various devices that may be configured to implement some embodiments in accordance with the current disclosure.

### DETAILED DESCRIPTION

The increasing range of sensing capabilities offered by modern mobile devices, such as cell phones, as well as their increasing computational resources make them ideal for applying VINS. Fusing visual and inertial measurements on a cell phone or other consumer-oriented mobile device, however, requires addressing two key problems, both of which are related to the low-cost, commercial-grade hardware used. First, the camera and inertial measurement unit (IMU) often have separate clocks, which may not be synchronized. Hence, visual and inertial measurements which may correspond to the same time instant will be reported with a time difference between them. Furthermore, this time offset may change over time due to inaccuracies in the sensors' clocks, or clock jitters from CPU overloading. Therefore, high-accuracy navigation on a cell phone requires modeling and online estimating such time parameters. Second, commercial-grade CMOS sensors suffer from the rolling-shutter effect; that is each pixel row of the imager is read at a different time instant, resulting in an ensemble distorted image. Thus, an image captured by a rolling-shutter camera under motion will contain bearing measurements to features which are recorded at different camera poses. Achieving high-accuracy navigation requires properly modeling and compensating for this phenomenon.

It is recognized herein that both the time synchronization and rolling-shutter effect correspond to a time offset between visual and inertial measurements. A new measurement model is introduced herein for fusing rolling-shutter images that have a time offset with inertial measurements. By exploiting the underlying kinematic motion model, one can employ the estimated linear and rotational velocity for relating camera measurements with IMU poses corresponding to different time instants.

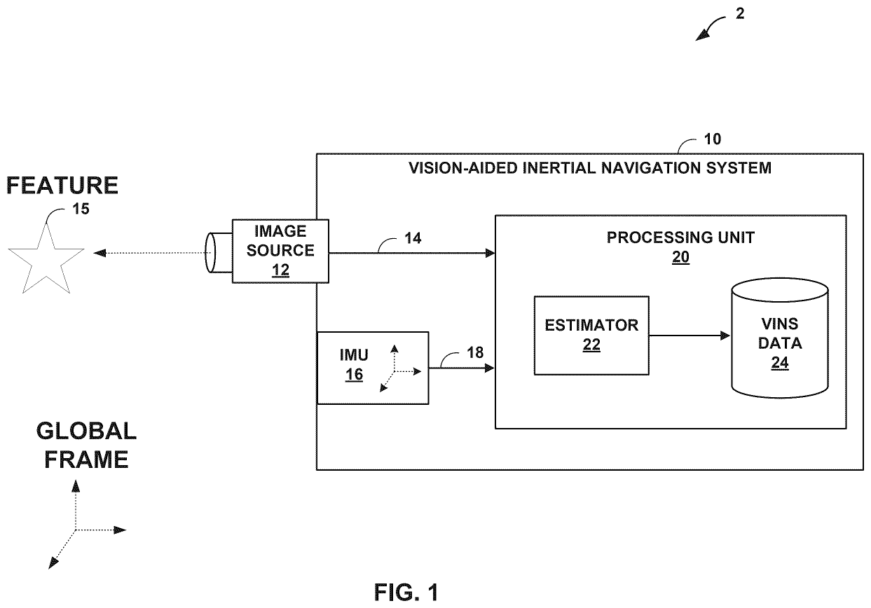

FIG. 1 is a block diagram illustrating a vision-aided inertial navigation system (VINS) 10 comprising at least one image source 12 and an inertial measurement unit (IMU) 14. VINS 10 may be a standalone device or may be integrated within our coupled to a mobile device, such as a robot, a mobile computing device such as a mobile phone, tablet, laptop computer or the like.

Image source 12 images an environment in which VINS 10 operates so as to produce image data 14. That is, image source 12 provides image data 14 that captures a number of features visible in the environment. Image source 12 may be, for example, one or more cameras that capture 2D or 3D images, a laser scanner or other optical device that produces a stream of 1D image data, a depth sensor that produces image data indicative of ranges for features within the environment, a stereo vision system having multiple cameras to produce 3D information, a Doppler radar and the like. In this way, image data 14 provides exteroceptive information as to the external environment in which VINS 10 operates. Moreover, image source 12 may capture and produce image data 14 at time intervals in accordance a first clock associated with the camera source. In other words, image source 12 may produce image data 14 at each of a first set of time instances along a trajectory within the three-dimensional (3D) environment, wherein the image data captures features 15 within the 3D environment at each of the first time instances.

IMU 16 produces IMU data 18 indicative of a dynamic motion of VINS 10. IMU 14 may, for example, detect a current rate of acceleration using one or more accelerometers as VINS 10 is translated, and detect changes in rotational attributes like pitch, roll and yaw using one or more gyroscopes. IMU 14 produces IMU data 18 to specify the detected motion. In this way, IMU data 18 provides proprioceptive information as to the VINS 10 own perception of its movement and orientation within the environment. Moreover, IMU 16 may produce IMU data 18 at time intervals in accordance a clock associated with the IMU [[camera source]]. In this way, IMU 16 produces IMU data 18 for VINS 10 along the trajectory at a second set of time instances, wherein the IMU data indicates a motion of the VINS along the trajectory. In many cases, IMU 16 may produce IMU data 18 at much faster time intervals than the time intervals at which image source 12 produces image data 14. Moreover, in some cases the time instances for image source 12 and IMU 16 may not be precisely aligned such that a time offset exists between the measurements produced, and such time offset may vary over time. In many cases the time offset may be unknown, thus leading to time synchronization issues.

In general, estimator 22 of processing unit 20 process image data 14 and IMU data 18 to compute state estimates for the degrees of freedom of VINS 10 and, from the state estimates, computes position, orientation, speed, locations of observable features, a localized map, an odometry or other higher order derivative information represented by VINS data 24. In one example, estimator 22 comprises an Extended Kalman Filter (EKF) that estimates the 3D IMU pose and linear velocity together with the time-varying IMU biases and a map of visual features 15. Estimator 22 may, in accordance with the techniques described herein, apply estimation techniques that compute state estimates for 3D poses of IMU 16 at each of the first set of time instances and 3D poses of image source 12 at each of the second set of time instances along the trajectory.

As described herein, estimator 12 applies an interpolation-based measurement model that allows estimator 12 to compute each of the poses for image source 12, i.e., the poses at each of the first set of time instances along the trajectory, as a linear interpolation of a selected subset of the poses computed for the IMU. In one example, estimator 22 may select the subset of poses for IMU 16 from which to compute a given pose for image source 12 as those IMU poses associated with time instances that are adjacent along the trajectory to the time instance for the pose being computed for the image source. In another example, estimator 22 may select the subset of poses for IMU 16 from which to compute a given pose for image source 12 as those IMU poses associated with time instances that are adjacent within a sliding window of cached IMU poses and that have time instances that are closest to the time instance for the pose being computed for the image source. That is, when computing state estimates in real-time, estimator 22 may maintain a sliding window, referred to as the optimization window, of 3D poses previously computed for IMU 12 at the first set of time instances along the trajectory and may utilize adjacent IMU poses within this optimization window to linearly interpolate an intermediate pose for image source 12 along the trajectory.

The techniques may be particularly useful in addressing the rolling shutter problem described herein. For example, in one example implementation herein the image source comprises at least one sensor in which image data is captured and stored in a plurality of rows or other set of data structures that are read out at different times. As such, the techniques may be applied such that, when interpolating the 3D poses for the image source, estimator 22 operates on each of the rows of image data as being associated with different ones of the time instances. That is, each of the rows (data structures) is associated with a different one of the time instances along the trajectory and, therefore associated with a different one of the 3D poses computed for the image source using the interpolation-based measurement model. In this way, each of the data structures (e.g., rows) of image source 12 may be logically treated as a separate image source with respect to state estimation.

Furthermore, in one example, when computing state estimates, estimator 22 may prevent projection of the image data and IMU data along at least one unobservable degree of freedom, referred to herein as Observability-Constrained Extended Kalman filter (OC-EKF). As one example, a rotation of the sensing system around a gravity vector may be undetectable from the input of a camera of the sensing system when feature rotation is coincident with the rotation of the sensing system. Similarly, translation of the sensing system may be undetectable when observed features are identically translated. By preventing projection of image data 14 and IMU data 18 along at least one unobservable degree of freedom, the techniques may improve consistency and reduce estimation errors as compared to conventional VINS.

Example details of an estimator 22 for a vision-aided inertial navigation system (VINS) in which the estimator enforces the unobservable directions of the system, hence preventing spurious information gain and reducing inconsistency, can be found in U.S. patent application Ser. No. 14/186,597, entitled “OBSERVABILITY-CONSTRAINED VISION-AIDED INERTIAL NAVIGATION,” filed Feb. 21, 2014, and U.S. Provisional Patent Application Ser. No. 61/767,701, filed Feb. 21, 2013, the entire content of each being incorporated herein by reference.

This disclosure applies an interpolation-based camera measurement model, targeting vision-aided inertial navigation using low-grade rolling-shutter cameras. In particular, the proposed device introduces an interpolation model for expressing the camera pose of each visual measurement, as a function of adjacent IMU poses that are included in the estimator's optimization window. This method offers a significant speedup compared to other embodiments for fusing visual and inertial measurements while compensating for varying time offset and rolling shutter. In one example, the techniques may be further enhanced by determining the system's unobservable directions when applying our interpolation measurement model, and may improve the VINS consistency and accuracy by employing an Observability-Constrained Extended Kalman filter (OC-EKF). The proposed algorithm was validated in simulation, as well as through real-time, online and offline experiments using a cell phone.

Most prior work on VINS assumes a global shutter camera perfectly synchronized with the IMU. In such a model, all pixel measurements of an image are recorded at the same time instant as a particular IMU measurement. However, this is unrealistic for most consumer devices mainly for two reasons:
(i) The camera and IMU clocks may not be synchronized. That is, when measuring the same event, the time stamp reported by the camera and IMU will differ.
(ii) The camera and IMU may sample at a different frequency and phase, meaning that measurements do not necessarily occur at the same time instant. Thus, a varying time delay, ta, between the corresponding camera and IMU measurements exists, which needs to be appropriately modelled.

In addition, if a rolling-shutter camera is used, an extra time offset introduced by the rolling-shutter effect, is accounted for. Specifically, the rolling-shutter camera reads the imager row by row, so the time delay for a pixel measurement in row m with image readout time tm can be computed as tₘ=mtᵣ, where tᵣ is the read time of a single row.

Although the techniques are described herein with respect to applying an interpolation-based measurement model to compute interpolated poses for image source 12 from closes poses computed for IMU 16, the techniques may readily be applied in reverse fashion such that IMU poses are computed from and relative to poses for the image source. Moreover, the techniques described herein for addresses time synchronization and rolling shutter issues can be applied to any device having multiple sensors where measurement data from the sensors are not aligned in time and may vary in time.

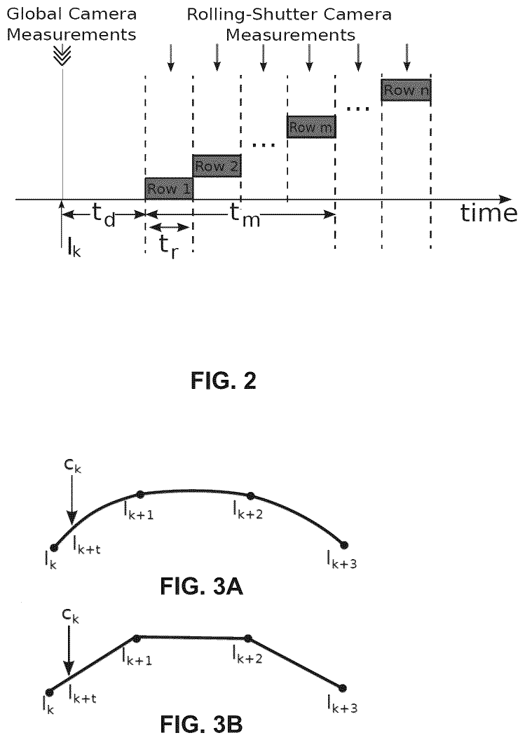

FIG. 2 is a graph illustrating the time synchronization and rolling-shutter effect. As depicted in FIG. 2, both the time delay of the camera, as well as the rolling-shutter effect can be represented by a single time offset, corresponding to each row of pixels. For a pixel measurement in the m-th row of the image, the time difference can be written as: t=t_{d}+tₘ.

Ignoring such time delays can lead to significant performance degradation. To address this problem, the proposed techniques introduce a measurement model that approximates the pose corresponding to a particular set of camera (image source) measurement as a linear interpolation (or extrapolation, if necessary) of the closest (in time) IMU poses, among the ones that comprise the estimator's optimization window.

FIGS. 3A and 3B are graphs that illustrate an example of a cell phone's trajectory between poses Iₖ and Iₖ₊₃. The camera measurement, Cₖ, is recorded at the time instant k+t between poses Iₖ and Iₖ₊₁. FIG. 3A shows the real cell phone trajectory. FIG. 3B shows the cell phone trajectory with linear approximation in accordance with the techniques described herein.

An interpolation-based measurement model is proposed for expressing the pose, Iₖ₊ₜ corresponding to image Cₖ (see FIG. 3A), as a function of the poses comprising the estimator's optimization window. Several methods exist for approximating a 3D trajectory as a polynomial function of time, such as the Spline method. Rather than using a high-order polynomial, a linear interpolation model is employed in the examples described herein. Such a choice is motivated by the short time period between two consecutive poses, Iₖ and Iₖ₊₁, that are adjacent to the pose Iₖ₊ₜ, which correspond to the recorded camera image. Although described with respect to linear interpolation, higher order interpolation can be employed, such as 2^{nd} or 3^{rd} order interpolation.

Specifically, defining {G} as the global frame of reference and an interpolation ratio λₖ∈[0, 1] (in this case, λₖ is the distance between Iₖ and Iₖ₊ₜ over the distance between Iₖ and Iₖ₊₁), the translation interpolation ^{G}P_{I}_{ₖ₊ₜ} between two IMU positions ^{G}P_{I}_{ₖ} and ^{G}P_{I}_{ₖ₊₁} expressed in {G}, can be easily approximated as:

$${}^{G} {P}_{{I}_{k + t}} = ( 1 - {λ}_{k} ) {}^{G} {P}_{{I}_{k}} + {λ}_{k} {}^{G} {P}_{{I}_{k + 1}} \qquad ( 1 )$$

In contrast, the interpolation of the frames' orientations is more complicated, due to the nonlinear representation of rotations. The proposed techniques takes advantage of two characteristics of the problem at hand for designing a simpler model: (i) The IMU pose is cloned at around 5 Hz (the same frequency as processing image measurements), thus the rotation between consecutive poses, Iₖ and Iₖ₊₁, is small during regular motion. The stochastic cloning is intended to maintain past IMU poses in the sliding window of the estimator. (ii) IMU pose can be cloned at the time instant closest to the image's recording time, thus the interpolated pose Iₖ₊ₜ is very close to the pose Iₖ and the rotation between them is very small.

Exploiting (i), the rotation between the consecutive IMU orientations, described by the rotation matrices

$${}_{{I}_{k}}^{G} {C}_{}^{} and {}_{{I}_{k + 1}}^{G} C ,$$

respectively expressed in {G}, can be written as:

$${}_{G}^{{I}_{k + 1}} {C}_{{I}_{k}}^{G} C = cos α I - sin α ⌊ Θ ⌋ + ( 1 - cos α ) Θ {Θ}^{T} ≃ I - α ⌊ Θ ⌋ \qquad ( 2 )$$

where small-angle approximation is employed, └Θ┘ denotes the skew-symmetric matrix of the 3×1 rotation axis, θ, and α is the rotation angle. Similarly, according to (ii) the rotation interpolation

$${}_{{I}_{k}}^{{I}_{k + 1}} C$$

between

$${}_{{I}_{k}}^{G} C and {}_{{I}_{k + 1}}^{G} C$$

can be written as:

$${}_{{I}_{k}}^{{I}_{k + 1}} C = cos ( {λ}_{k} α ) I - sin ( {λ}_{k} α ) ⌊ Θ ⌋ + ( 1 - cos ( {λ}_{k} α ) ) Θ {Θ}^{T} ≃ I - {λ}_{k} α ⌊ Θ ⌋ \qquad ( 3 )$$

If α└Θ┘ from equations 2 and 3 is substituted,

$${}_{{I}_{k}}^{{I}_{k + 1}} C$$

can be expressed in terms of two consecutive rotations:

$${}_{{I}_{k}}^{{I}_{k + 1}} C ≃ ( 1 - {λ}_{k} ) 1 + {}_{G}^{{I}_{k}} C {}_{G}^{{I}_{k + 1}} C \qquad ( 4 )$$

This interpolation model is exact at the two end points (λₖ=0 or 1), and less accurate for points in the middle of the interpolation interval (i.e., the resulting rotation matrix does not belong to SO(3)). Since the cloned IMU poses can be placed as close as possible to the reported time of the image, such a model can fit the purposes of the desired application.

In one example, the proposed VINS 10 utilizes a rolling-shutter camera with a varying time offset. The goal is to estimate the 3D position and orientation of a device equipped with an IMU and a rolling-shutter camera. The measurement frequencies of both sensors are assumed known, while there exists an unknown time offset between the IMU and the camera timestamps. The proposed algorithm applies a linear-complexity (in the number of features tracked) visual-inertial odometry algorithm, initially designed for inertial and global shutter camera measurements that are perfectly time synchronized. Rather than maintaining a map of the environment, the estimator described herein may utilize Multi-State Constrained Kalman Filter (MSCKF) to marginalize all observed features, exploiting all available information for estimating a sliding window of past camera poses. Further techniques are described in U.S. patent application Ser. No. 12/383,371, entitled “VISION-AIDED INERTIAL NAVIGATION,” the entire contents of which are incorporated herein by reference. The proposed techniques utilize a state vector, and system propagation uses inertial measurements. It also introduces the proposed measurement model and the corresponding EKF measurement update.

The state vector estimate is:

$$x = [ \begin{matrix}{x}_{I} & {x}_{{I}_{k + n - 1}} & … & {x}_{{I}_{k}}\end{matrix} \qquad ( 5 )$$

where xₗ denotes the current robot pose, and x₁_{ᵢ}, for I=k+n−1, . . . , k are the cloned IMU poses in the sliding window, corresponding to the time instants of the last n camera measurements. Specifically, the current robot pose is defined as:

$${x}_{1} = {[ \begin{matrix}{}_{}^{I} {q}_{G}^{T} & {}_{}^{G} {v}_{I}^{T} & {}_{}^{G} {p}_{I}^{T} & {}_{} {b}_{α}^{T} & {}_{} {b}_{g}^{T} & {λ}_{d} & {λ}_{r}\end{matrix} ]}^{T}$$

where ^{I}q_{G} is the quaternion representation of the orientation of {G} in the IMU's frame of reference {I}, ^{I}v_{G} and ^{I}p_{G} are the velocity and position of {I} in {G} respectively, while bₐ and b_{g} correspond to the gyroscope and accelerometer biases. The interpolation ratio can be divided into a time-variant part, λ_{d}, and a time-invariant part, λᵣ. In our case, λ_{d} corresponds to the IMU-camera time offset, t_{d}, while λᵣ corresponds to the readout time of an image-row, tᵣ. Specifically,

$${λ}_{d} = \frac{{t}_{d}}{{t}_{intvl}} {λ}_{r} = \frac{{t}_{r}}{{t}_{intvl}} \qquad ( 6 )$$

where tᵢₙₜᵥₗ is the time interval between two consecutive IMU poses (known). Then, the interpolation ratio for a pixel measurement in the m-th row of the image is written as:

$$λ = {λ}_{d} + m {λ}_{r} \qquad ( 7 )$$

When a new image measurement arrives, the IMU pose is cloned at the time instant closest to the image recording time. The cloned IMU poses xₗ_{ᵢ} are defined as:

$${x}_{{I}_{i}} = {[ \begin{matrix}{}^{{I}_{i}} {q}_{G}^{T} & {}^{G} {p}_{{I}_{i}}^{T} & {λ}_{{d}_{i}}\end{matrix} ]}^{T}$$

where

$${}^{{I}_{i}} {q}_{G}^{T} , {}^{G} {p}_{{I}_{i}}^{T} , {λ}_{{d}_{i}}$$

are cloned at the time instant that the i-th image was recorded. Note, that λ_{d}_{ᵢ} is also cloned because the time offset between the IMU and camera may change over time.

According to one case, for a system with a fixed number of cloned IMU poses, the size of the system's state vector depends on the dimension of each cloned IMU pose. In contrast to an approach proposed in Mingyang Li, Byung Hyung Kim, and Anastasios I. Mourikis. Real-time motion tracking on a cellphone using inertial sensing and a rolling-shutter camera. In Proc. of the IEEE International Conference on Robotics and Automation, pages 4697-4704, Karlsruhe, Germany, May 6-10 2013 (herein, “Li”), which requires to also clone the linear and rotational velocities, our interpolation-based measurement model reduces the dimension of the cloned state from 13 to 7. This smaller clone state size significant minimizes the algorithm's computational complexity.

When a new inertial measurement arrives, it is used to propagate the EKF state and covariance. The state and covariance propagation of the current robot pose and the cloned IMU poses are now described.

Current pose propagation: The continuous-time system model describing the time evolution of the states is:

$${}^{I} {\dot{q}}_{G} ( t ) = \frac{1}{2} {Ω ( {ω}_{m} ( t ) - {b}_{g} ( t ) - {n}_{g} ( t ) )}^{I} {q}_{G} ( t ) {}^{G} {\dot{v}}_{I} ( t ) = {C ( {}^{I} {q}_{G} ( t ) )}^{T} ( {a}_{m} ( t ) - {b}_{a} ( t ) - {n}_{a} ( t ) ) + {}^{G} g {}^{G} {\dot{p}}_{I} ( t ) = {}^{G} {v}_{I} ( t ) {\dot{b}}_{a} ( t ) = {n}_{w a} {\dot{b}}_{g} ( t ) = {n}_{w g} {\dot{λ}}_{d} ( t ) = {n}_{td} {\dot{λ}}_{r} ( t ) = 0 \qquad ( 8 )$$

where C(^{I}q_{G} (t)) denotes the rotation matrix corresponding to ^{I}q_{G} (t), ωₘ(t) and aₘ(t) are the rotational velocity and linear acceleration measurements provided by the IMU, while ng and nₐ are the corresponding white Gaussian measurement noise components. ^{G}g denotes the gravitational acceleration in {G}, while n_{wa} and n_{wg} are zero-mean white Gaussian noise processes driving the gyroscope and accelerometer biases b_{g} and bₐ. Ω(ω) is defined as

$$[ \begin{matrix}- ⌊ ω ⌋ & ω \\ - {ω}^{2} & 0\end{matrix} ]$$

Finally, n_{td} is a zero-mean white Gaussian noise process modelling the random walk of λ_{d} (corresponding to the time offset between the IMU and camera). For state propagation, the propagation is linearized around the current state estimate and the expectation operator is applied. For propagating the covariance, the error-state vector of the current robot pose is defined as:

$$\tilde{x} = {[ \begin{matrix}{}^{I} δ {θ}_{G}^{T} & {}^{G} {\tilde{v}}_{I}^{T} & {}^{G} {\tilde{p}}_{I}^{T} & {}^{G} {\tilde{p}}_{f}^{T} & {\tilde{b}}_{a}^{T} & {\tilde{b}}_{g}^{T} & {\tilde{λ}}_{d} & {\tilde{λ}}_{r}\end{matrix} ]}^{T} \qquad ( 9 )$$

For quaternion q, a multiplicative error model

$$δ \overline{q} = \overline{q} ⊗ {\hat{\overline{q}}}^{- 1} ≃ {[ \frac{1}{2} δ {Θ}^{T} 1 ]}^{T}$$

is employed where δθ is a minimal representation of the attitude error.

Then, the linearized continuous-time error-state equation can be written as:

$$\dot{\tilde{x}} = {F}_{E \tilde{X}} + {G}_{E} w \qquad ( 10 )$$

where

$$w = {[ \begin{matrix}{n}_{g}^{T} & {n}_{wg}^{T} & {n}_{a}^{T} & {n}_{wa}^{T} & {n}_{td}\end{matrix} ]}^{T}$$

is modelled as a zero-mean white Gaussian process with auto-correlation [symbol] [w(t)w^{T}(τ)]=Q_{E}δ(1−τ), and F_{E}, G_{E} are the continuous time error-state transition and input noise matrices, respectively. The discrete-time state transition matrix Φ_{k+1,k} and the system covariance matrix Qₖ from time tₖ to tₖ₊₁ can be computed as:

$${Φ}_{k + 1 , k} = Φ ( {t}_{k + 1} , {t}_{k} ) = exp ( {\int }_{{t}_{k}}^{{t}_{k + 1}} {F}_{E ( τ ) d τ} ) {Q}_{k} = {\int }_{{t}_{k}}^{{t}_{k + 1}} {Φ}_{( {t}_{k + 1} , τ )} {G}_{E} {Q}_{E} {G}_{E}^{T} {Φ}_{( {t}_{k + 1} , τ ) d τ}^{T} \qquad ( 11 )$$

If the covariance corresponding to the current pose is defined as P_{EE}_{_{K|k}}, the propagated covariance P_{EE}_{_{K+1|k}}, can be determined as

$${P}_{E {E}_{k + 1 \vert k}} = {Φ}_{k + 1 , k} {P}_{E {E}_{k \vert k}} {Φ}_{k + 1 , k}^{T} + {Q}_{k} \qquad ( 12 )$$

where x_{k|l} denotes the estimate of x at time step k using measurements up to time step l.

During propagation, the state and covariance estimates of the cloned robot poses do not change, however their cross-correlations with the current IMU pose need to be propagated. If P is defined as the covariance matrix of the whole state x, P_{CC}_{_{k|k}}, as the covariance matrix of the cloned poses, and P_{EC}_{_{k|k}} as the correlation matrix between the errors in the current pose and cloned poses, the system covariance matrix is propagated as:

$${P}_{k + 1 \vert k} = [ \begin{matrix}{P}_{E {E}_{k + 1 \vert k}} & {Φ}_{k} {P}_{{EC}_{k \vert k}} \\ {P}_{{EC}_{k \vert k}}^{T} {Φ}_{k + 1 , k}^{T} & {P}_{C {C}_{k \vert k}}\end{matrix} ] \qquad ( 13 )$$

with Φ_{k+1,k} defined in equation 11.

Each time the camera records an image, a stochastic clone comprising the IMU pose, ^{I}q_{G}, ^{G}p_{I}, and the interpolation ratio, λ_{d}, describing its time offset from the image, is created. This process enables the MSC-KF to utilize delayed image measurements; in particular, it allows all observations of a given feature fⱼ to be processed during a single update step (when the first pose that observed fⱼ is about to be marginalized), while avoiding to maintain estimates of this feature, in the state vector.

For a feature fⱼ observed in the m-th row of the image associated with the IMU pose Iₖ, the interpolation ratio can be expressed as λₖ=Δ_{d}_{ₖ}+mλᵣ where λ_{d}_{ₖ} is the interpolation ratio corresponding to the time offset between the clocks of the two sensors at time step k, and mλᵣ is the contribution from the rolling-shutter effect. The corresponding measurement model is given by:

$${z}_{k}^{( j )} = h ( {}^{{I}_{k + t}} {p}_{fj} ) + {n}_{k}^{( j )} , {n}_{k}^{( j )} ∼ N ( 0 , {R}_{k , j} ) \qquad ( 14 )$$

where ^{I}^{ₖ₊ₜ}p_{f}_{ⱼ} is the feature position expressed in the camera frame of reference at the exact time instant that the m-th image-row was read. Without loss of generality, it is assumed that the camera is intrinsically calibrated with the camera perspective measurement model, h, described by:

$$h ( {}^{{I}_{k + t}} {p}_{fj} ) = [ \begin{matrix}\frac{{}^{{I}_{k + t}} {p}_{fj} ( 1 )}{{}^{{I}_{k + t}} {p}_{fj} ( 3 )} \\ \frac{{}^{{I}_{k + t}} {p}_{fj} ( 2 )}{{}^{{I}_{k + t}} {p}_{fj} ( 3 )}\end{matrix} ] \qquad ( 15 )$$

where ^{I}^{ₖ₊ₜ}p_{f}_{ⱼ}(i), i=1, 2, 3 represents the i-th element of ^{I}^{ₖ₊ₜ}p_{f}_{ⱼ}. Expressing ^{I}^{ₖ₊ₜ}p_{f}_{ⱼ} as a function of the states that is estimated, results in:

$${}^{{I}_{k + t}} {p}_{fj} = {}_{G}^{{}^{{I}_{k + t}}} C ( {}^{G} {p}_{fj} - {}^{G} {p}_{{I}_{k + t}} ) = {}_{{I}_{k}}^{{I}_{k + t}} C {}_{G}^{{I}_{k}} C ( {}^{G} {p}_{fj} - {}^{G} {p}_{{I}_{k + t}} ) \qquad ( 16 )$$

### Substituting

$${}_{{I}_{k}}^{{I}_{k + t}} C and {}^{G} {p}_{{I}_{k + t}} ,$$

from equations 4 and 1, equation 16 can be rewritten as:

$${}^{{I}_{k + t}} {p}_{fj} = ( ( 1 - {λ}_{k} ) I + {λ}_{k} {}_{G}^{{I}_{k}} C {}_{{I}_{k + 1}}^{G} C ) {}_{G}^{{I}_{k}} C ( {}^{G} {p}_{fj} - ( ( 1 - {λ}_{k} ) {}^{G} {p}_{{I}_{k}} + {λ}_{k} {}^{G} {p}_{{I}_{k + 1}} ) ) \qquad ( 17 )$$

Linearizing the measurement model about the filter estimates, the residual corresponding to this measurement can be computed as

$${r}_{k}^{( j )} = {z}_{k}^{( j )} - h ( {}^{{I}_{k + t}} {\hat{p}}_{fj} ) ≃ {H}_{{x}_{{I}_{k}}}^{( j )} {\tilde{x}}_{{I}_{k}} + {H}_{{x}_{{I}_{k + 1}}}^{( j )} {\tilde{x}}_{{I}_{k + 1}} + {H}_{fk}^{( j )} {}^{G} {\tilde{p}}_{fj} + {H}_{{λ}_{{r}_{k}}}^{( j )} {\tilde{λ}}_{r} + {n}_{k}^{( j )} \qquad ( 18 )$$

where

$${H}_{{X}_{{I}_{k}}}^{( j )} , {H}_{{X}_{{I}_{k + 1}}}^{( j )} , {H}_{{f}_{j}}^{( j )} , and {H}_{{λ}_{{r}_{k}}}^{( j )}$$

are the Jacobians with respect to the cloned poses Xₗ_{ₖ}, Xₗ_{ₖ₊₁}, the feature position ^{G}p_{f}_{ⱼ}, and the interpolation ratio corresponding to the image-row readout time, λᵣ, respectively.

By stacking the measurement residuals corresponding to the same point feature, fⱼ:

$${r}^{( j )} = [ \begin{matrix}{r}_{k} \\ ⋮ \\ {r}_{k + n - 1}^{( j )}\end{matrix} ] ≃ {H}_{{x}_{c l o n e}}^{( j )} {\tilde{x}}_{c l o n e} + {H}_{f}^{( j )} {}^{G} {\tilde{p}}_{fj} + {H}_{{λ}_{r}}^{( j )} {\tilde{λ}}_{r} + {n}^{( j )} \qquad ( 19 )$$

where

$${\tilde{X}}_{c l o n e} = {[ {\tilde{X}}_{{I}_{k + n - 1}}^{T} … {\tilde{X}}_{{I}_{k}}^{T} ]}^{T}$$

is the error in the cloned pose estimates, while

$${H}_{f}^{( j )} and {H}_{{λ}_{r}}^{( j )}$$

is the corresponding Jacobian matrix. Furthermore,

$${H}_{{X}_{j}}^{( j )}$$

are the Jacobians corresponding to the feature and interpolation ratio contributed by the readout time error, respectively.

To avoid including feature fⱼ in the state vector, the error term is marginalized ^{G}\tilde{p}_{f}_{ⱼ} by multiplying both sides of equation 19 with the left nullspace, V, of the feature's Jacobian matrix

$${H}_{f}^{( j )} ,$$

i.e.,

$${r}_{o}^{( j )} ≃ {V}^{T} {H}_{{x}_{c l o n e}}^{( j )} {\tilde{x}}_{c l o n e} + {V}^{T} {H}_{f}^{( j )} {}^{G} {\tilde{p}}_{fj} + {V}^{T} {H}_{{λ}_{r}}^{( j )} {\tilde{λ}}_{r} + {V}^{T} {n}^{( j )} {=}^{Δ} {H}_{o}^{( j )} \tilde{x} + {n}_{o}^{( j )} \qquad ( 20 )$$

where

$${r}_{o}^{( j )} {=}^{△} {V}^{T} {r}^{( j )} .$$

Note V does not have to be computed explicitly. Instead, this operation can be applied efficiently using in-place Givens rotations.

Previously, the measurement model for each individual feature was formulated. Specifically, the time-misaligned camera measurements was compensated for with the interpolation ratio corresponding to both the time offset between sensors and the rolling shutter effect. Additionally, dependence of the measurement model on the feature positions was removed. EKF updates are made using all the available measurements from L features.

Stacking measurements of the form in equation 2, originating from all features, fⱼ, j=1, . . . , L, yields the residual vector:

$$r ≃ H \tilde{x} + n \qquad ( 21 )$$

where H is a matrix with block rows the Jacobians

$${H}_{o}^{( j )} ,$$

while r and n are the corresponding residual and noise vectors, respectively.

In practice, H is a tall matrix. The computational cost can be reduced by employing the QR decomposition of H denoted as:

$$H = [ \begin{matrix}{Q}_{1} & {Q}_{2}\end{matrix} ] [ \begin{matrix}{R}_{H} \\ 0\end{matrix} ] \qquad ( 22 )$$

where [Q₁ Q₂] is an orthonormal matrix, and R_{H} is an upper triangular matrix. Then, the transpose of [Q₁ Q₂] can be multiplied to both sides of equation 21 to obtain:

$$[ \begin{matrix}{Q}_{1}^{T} & r \\ {Q}_{2}^{T} & r\end{matrix} ] = [ \begin{matrix}{R}_{H} \\ 0\end{matrix} ] \tilde{x} + [ \begin{matrix}{Q}_{1}^{T} & n \\ {Q}_{2}^{T} & n\end{matrix} ] \qquad ( 23 )$$

It is clear that all information related to the error in the state estimate is included in the first block row, while the residual in the second block row corresponds to noise and can be completely discarded. Therefore, first block row of equation 23 is needed as residual for the EKF update:

$${r}_{n} = {Q}_{1}^{T} r = {R}_{H} \tilde{x} + {Q}_{1}^{T} n \qquad ( 24 )$$

The Kalman gain is computed as:

$$K = {{PR}_{H}^{T} ( {R}_{H} {PR}_{H}^{T} + R )}^{- 1} \qquad ( 25 )$$

where R is the measurement noise. If the covariance of the noise n is defined as σ²I, then

$$R = {σ}^{2} {Q}_{1}^{T} {Q}_{1} = {σ}^{2} I .$$

Finally, the state and covariance updates are determined as:

$${x}_{k + 1 \vert k + 1} = {x}_{k + 1 \vert k} + {Kr}_{n} \qquad ( 26 )$$

$${P}_{k + 1 \vert k + 1} = P - {{PR}_{H}^{T} ( {R}_{H} {PR}_{H}^{T} + R )}^{- 1} {R}_{H} P \qquad ( 27 )$$

Defining the dimension of H to be m×n, the computational complexity for the measurement compression QR in equation 22 will be

$$O ( 2 {mn}^{n} - \frac{2}{3} {n}^{3} ,$$

and roughly O(n³) for matrix multiplications or inversions in equations 25 and 26. Since H is a very tall matrix, and m is, typically, much larger than n, the main computational cost of the MSC-KF corresponds to the measurement compression QR. It is important to note that the number of columns n depends not only on the number of cloned poses, but also on the dimension of each clone.

For the proposed approach this would correspond to 7 states per clone (i.e., 6 for the camera pose, and a scalar parameter representing the time-synchronization). In contrast, one recent method proposed in Mingyang Li, Byung Hyung Kim, and Anastasios I. Mourikis. Real-time motion tracking on a cellphone using inertial sensing and a rolling-shutter camera. In Proc. of the IEEE International Conference on Robotics and Automation, pages 4697-4704, Karlsruhe, Germany, May 6-10 2013 (herein “Li”) requires 13 states per clone (i.e., 6 for the camera pose, 6 for its corresponding rotational and linear velocities, and a scalar parameter representing the time-synchronization). This difference results in a 3-fold computational speedup compared to techniques in Li, for this particular step of an MSCKF update. Furthermore, since the dimension of the system is reduced to almost half through the proposed interpolation model, all the operations in the EKF update will also gain a significant speedup. Li's approach requires the inclusion of the linear and rotational velocities in each of the clones in order to be able to fully compute (update) each clone in the state vector. In contrast, the techniques described are able to exclude storing the linear and rotational velocities for each IMU clone, thus leading to a reduced size for each clone in the state vector, because linear interpolation is used to express the camera feature measurement as a function of two or more IMU clones (or camera poses) already in the state vector. Alternatively, image source clones could be maintained within the state vector, and poses for the IMU at time stamps when IMU data is received could be similarly determined as interpolations from surrounding (in time) camera poses, i.e., interpolation is used to express the IMU feature measurement as a function of two or more cloned camera poses already in the state vector

Linearization error may cause the EKF to be inconsistent, thus also adversely affecting the estimation accuracy. This may be addressed by employing the OC-EKF.

A system's unobservable directions, N, span the nullspace of the system's observability matrix M:

$$MN = 0 \qquad ( 28 )$$

where by defining Φ_{k,1}≙Φ_{k,k-1} . . . Φ_{2,1} as the state transition matrix from time step 1 to k, and Hₖ as the measurement Jacobian at time step k, M can be expressed as:

$$M = [ \begin{matrix}{H}_{1} \\ {H}_{2} {Φ}_{2 , 1} \\ ⋮ \\ {H}_{k} {Φ}_{k , 1}\end{matrix} ] \qquad ( 29 )$$

However, when the system is linearized using the current estimate in equation 28, in general, does not hold. This means the estimator gains spurious information along unobservable directions and becomes inconsistent. To address this problem, the OC-EKF enforces equation 28 by modifying the state transition and measurement Jacobian matrices according to the following two observability constraints:

$${N}_{k + 1} = {Φ}_{k + 1 , k} {N}_{k} \qquad ( 30 )$$

$${H}_{k} {N}_{k} = 0 , ∀ k > 0 \qquad ( 31 )$$

where Nₖ and Nₖ₊₁ are the system's unobservable directions evaluated at time-steps k and k+1. This method will be applied to this system to appropriately modify Φ_{k+1,k}, as defined in equation 11, and Hₖ, and thus retain the system's observability properties.

In one embodiment, it is shown that the inertial navigation system aided by time-aligned global-shutter camera has four unobservable directions: one corresponding to rotations about the gravity vector, and three to a global translations. Specifically, the system's unobservable directions with respect to the IMU pose and feature position,

$${[ \begin{matrix}{}^{I} {q}_{G}^{T} & {b}_{g}^{T} & {}^{G} {v}_{I}^{T} & {b}_{a}^{T} & {}^{G} {p}_{I}^{T} & {}^{G} {p}_{f}^{T}\end{matrix} ]}^{T} ,$$

can be written as:

$$N {=}^{△} [ \begin{matrix}{}_{G}^{I} Cg & {0}_{3 \times 3} \\ {0}_{3 \times 1} & {0}_{3 \times 3} \\ - ⌊ {}_{I}^{G} v ⌋ g & {0}_{3 \times 3} \\ {0}_{3 \times 1} & {0}_{3 \times 3} \\ - ⌊ {}_{I}^{G} p ⌋ g & {I}_{3 \times 3} \\ - ⌊ {}^{G} {p}_{f} ⌋ g & {I}_{3 \times 3}\end{matrix} ] = [ \begin{matrix}{N}_{r} \\ {N}_{f}\end{matrix} ] \qquad ( 32 )$$

Once system's unobservable directions have been determined, the state transition matrix, Φ_{k+1,k}, can be modified according to the observability constant in equation 30.

$${N}_{{r}_{k + 1}} = {Φ}_{k + 1 , k} {N}_{{r}_{k}} \qquad ( 33 )$$

where Φ_{k+1,k} has the following structure:

$$[ \begin{matrix}{Φ}_{11} & {Φ}_{12} & {0}_{3} & {0}_{3} & {0}_{3} \\ {0}_{3} & {I}_{3} & {0}_{3} & {0}_{3} & {0}_{3} \\ {Φ}_{31} & {Φ}_{32} & {I}_{3} & {Φ}_{34} & {0}_{3} \\ {0}_{3} & {0}_{3} & {0}_{3} & {I}_{3} & {0}_{3} \\ {Φ}_{51} & {Φ}_{52} & δ {tI}_{3} & {Φ}_{54} & {I}_{3}\end{matrix} ] \qquad ( 34 )$$

Equation 33 is equivalent to the following three constraints:

$${Φ}_{11} {}_{G}^{{I}_{k}} Cg = {}_{G}^{{I}_{k + 1}} Cg \qquad ( 35 )$$

$${Φ}_{31} {}_{G}^{{I}_{k}} Cg = ⌊ {}^{G} {v}_{{I}_{k}} ⌋ g - ⌊ {}^{G} {v}_{{I}_{k + 1}} ⌋ g \qquad ( 36 )$$

$${Φ}_{51} {}_{G}^{{I}_{k}} Cg = δ t ⌊ {}^{G} {v}_{{I}_{k}} ⌋ g + ⌊ {}^{G} {p}_{{I}_{k}} ⌋ g - ⌊ {}^{G} {p}_{{I}_{k + 1}} ⌋ g \qquad ( 37 )$$

in which equation 35 can be easily satisfied by modifying

$${Φ}_{11}^{*} = {}_{G}^{{I}_{k + 1}} C {}_{G}^{{I}_{k + 1}} {C}^{T} .$$

Both equations 36 and 37 are in the form Au=w, where u and w are fixed. This disclosure seeks to select another matrix A* that is closest to the A in the Frobenius norm sense, while satisfying constraints 36 and 37. To do so, the following optimization problem is formulated

$${A}^{*} = arg min {‖ {A}^{*} - A ‖}_{ℱ}^{2} \qquad ( 38 )$$

$${A}^{*}$$

$$s . t . {A}^{*} u = w$$

where ∥·∥_{F} denotes the Frobenius matrix norm. The optimal A* can be determined by solving its KKT optimality condition, whose solution is

$${A}^{*} = A - ( Au - w ) {( {u}^{T} u )}^{- I} {u}^{T} \qquad ( 39 )$$

During the update at time step k, the nonzero elements of the measurement Jacobian Hₖ, as shown in equation 18, are

$$[ \begin{matrix}{H}_{{I}_{{k}_{{q}_{G}}}} & {H}_{{G}_{{p}_{{I}_{k}}}} & {H}_{{I}_{k + {1}_{{q}_{G}}}} & {H}_{{G}_{{p}_{{I}_{k + 1}}}} & {H}_{{G}_{{p}_{f}}} & {H}_{{λ}_{r}}\end{matrix} ] ,$$

corresponding to the elements of the state vector involved in the measurement model (as expressed by the subscript).

Since two IMU poses are involved in the interpolation-based measurement model, the system's unobservable directions, at time step k, can be shown to be:

$${N}_{k}^{′} {=}^{△} {[ \begin{matrix}{N}_{{r}_{k}}^{T} & {N}_{{r}_{k + 1}}^{T} & {N}_{{f}_{k}}^{T} & 0\end{matrix} ]}^{T} \qquad ( 40 )$$

where Nᵣ_{ᵢ}, i=k, k+1, and N_{f}_{ₖ} are defined in (32), while the zero corresponds to the interpolation ratio. This can be achieved straightforwardly by finding the nullspace of the linearized system's Jacobian. If

$${N}_{k}^{′} {=}^{△} [ \begin{matrix}{N}_{k}^{g} & {N}_{k}^{p}\end{matrix} ] ,$$

where

$${N}_{k}^{g}$$

is the first column of Nₖ′ corresponding to the rotation about the gravity, and

$${N}_{k}^{p}$$

is the other three columns corresponding to global translations, then according to equation 31, Hₖ is modified to fulfill the following two constraints:

$${H}_{k} {N}_{k}^{p} = 0 ⇔ {H}_{{G}_{{p}_{{I}_{k}}}} + {H}_{{G}_{{p}_{f}}} = 0 \qquad ( 41 )$$

$${H}_{k} {N}_{k}^{g} = 0 ⇔ [ \begin{matrix}{H}_{{I}_{{k}_{{q}_{G}}}} & {H}_{{G}_{{p}_{{I}_{k}}}} & {H}_{{I}_{k + {1}_{{q}_{G}}}} & {H}_{{G}_{{p}_{{I}_{k + 1}}}} & {H}_{{G}_{{p}_{f}}}\end{matrix} ] [ \begin{matrix}{}_{G}^{{I}_{k}} Cg \\ - ⌊ {}^{G} {p}_{{I}_{k}} ⌋ g \\ {}_{G}^{{I}_{k + 1}} Cg \\ - ⌊ {}^{G} {p}_{{I}_{k + 1}} ⌋ g \\ - ⌊ {}^{G} {p}_{f} ⌋ g\end{matrix} ] = 0 \qquad ( 42 )$$

Substituting H_{G}_{_{pf}} from equations 41 and 42, the observability constraint for the measurement Jacobian matrix is written as:

$$[ \begin{matrix}{H}_{{I}_{{k}_{{q}_{G}}}} & {H}_{{G}_{{p}_{{I}_{k}}}} & {H}_{{I}_{k + {1}_{{q}_{G}}}} & {H}_{{G}_{{p}_{{I}_{k + 1}}}}\end{matrix} ] [ \begin{matrix}{}_{G}^{{I}_{k}} Cg \\ ( ⌊ {}^{G} {p}_{f} ⌋ - ⌊ {}^{G} {p}_{{I}_{k}} ⌋ ) g \\ {}_{G}^{{I}_{k + 1}} Cg \\ ( ⌊ {}^{G} {p}_{f} ⌋ ⌊ {}^{G} {p}_{{I}_{k + 1}} ⌋ ) g\end{matrix} ] = 0 \qquad ( 43 )$$

which is of the form Au=0. Therefore.

$${H}_{{I}_{{k}_{{q}_{G}}}}^{*} , {H}_{{G}_{{p}_{{I}_{k}}}}^{*} , {H}_{{I}_{k + {1}_{{q}_{G}}}}^{*} , and {H}_{{G}_{{p}_{{I}_{k + 1}}}}^{*}$$

can be analytically determined using equations 38 and 39, for the special case when w=0. Finally according to equation 41,

$${H}_{{G}_{{p}_{f}}}^{*} = - {H}_{{G}_{{p}_{{I}_{k}}}}^{*} - {H}_{{G}_{{p}_{{I}_{k + 1}}}}^{*} .$$

The simulations involved a MEMS-quality IMU, as well as a rolling-shutter camera with a readout time of 30 msec. The time offset between the camera and the IMU clock was modelled as a random walk with mean 3.0 msec and standard deviation 1.0 msec. The IMU provided measurements at a frequency of 100 Hz, while the camera ran at 10 Hz. The sliding-window state contained 6 cloned IMU poses, while 20 features were processed during each EKF update.

The following variants of the MSC-KF were compared:
Proposed: The proposed OC-MSC-KF, employing an interpolation-based measurement model.
w/o OC: The proposed interpolation-based MSC-KF without using OC-EKF.
Li: An algorithm described in Mingyang Li, Byung Hyung Kim, and Anastasios I. Mourikis, Real-time motion tracking on a cellphone using inertial sensing and a rolling-shutter camera, In Proc. of the IEEE International Conference on Robotics and Automation, pages 4697-4704, Karlsruhe, Germany, May 6-10 2013 (herein, “Li”) that uses a constant velocity model, and thus also clones the corresponding linear and rotational velocities, besides the cell phone pose, in the state vector.

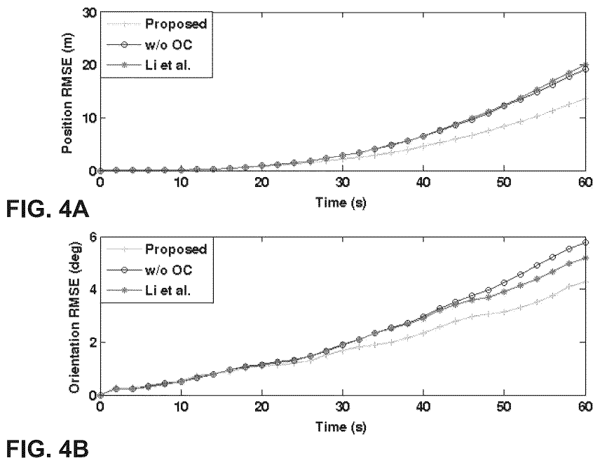

The estimated position and orientation root-mean square errors (RMSE) are plotted in FIGS. 4A and 4B, respectively. By comparing Proposed and w/o OC, it is evident that employing the OC-EKF improves the position and orientation estimates. Furthermore, the proposed techniques achieves lower RMSE compared to Li, at a significantly lower computational cost.

In addition to simulations, the performance of the proposed algorithm was validated using a Samsung S4 mobile phone. The S4 was equipped with 3-axial gyroscopes and accelerometers, a rolling-shutter camera, and a 1.6 GHz quad-core Cortex-A15 ARM CPU. Camera measurements were acquired at a frequency of 15 Hz, while point features were tracked across different images via an existing algorithm. For every 230 ms or 20 cm of displacement, new Harris corners were extracted while the corresponding IMU pose was inserted in the sliding window of 10 poses, maintained by the filter. The readout time for an image was about 30 ms, and the time offset between the IMU and camera clocks was approximately 10 ms. All image-processing algorithms were optimized using an ARM NEON assembly. The developed system required no initial calibration of the IMU biases, rolling-shutter time, or camera-IMU clock offset, as these parameters were estimated online. Since no high-precision ground truth is available, in the end of the experiments, the cell phone was brought back to the initial position and this allowed for examination of any final position error.

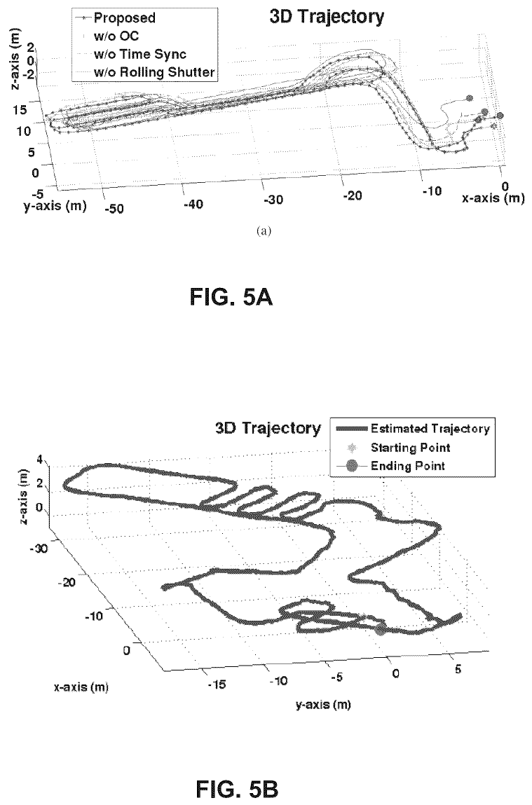

Two experiments were performed. The first, as shown in FIG. 5A, served the purpose of demonstrating the impact of not employing the OC-EKF or ignoring the time synchronization and rolling shutter effects, while the second, as shown in FIG. 5B, demonstrates the performance of the developed system, during an online experiment.

The first experiment comprises a loop of 277 meters, with an average velocity of 1.5 m/sec. The final position errors of Proposed, w/o OC, and the following two algorithms are examined:
w/o Time Sync: The proposed interpolation-based OC-MSC-KF considering only the rolling shutter, but not the time synchronization.
w/o Rolling Shutter: The proposed interpolation-based OC-MSC-KF considering only the time synchronization, but not the rolling shutter.

The 3D trajectories of the cell phone estimated by the above algorithms are plotted in FIG. 5A, and their final position errors are reported in Table. I.

TABLE I
LOOP CLOSURE ERRORS

| Estimation | Final | Pct. |
|---|---|---|
| Algorithm | Error (m) | (%) |
| Proposed | 1.64 | 0.59 |
| w/o OC | 2.16 | 0.79 |
| w/o Time Sync | 2.46 | 0.91 |
| w/o Rolling Shutter | 5.02 | 1.88 |

Several key observations can be made. First, by utilizing the OC-EKF, the position estimation error decreases significantly (from 0:79% to 0:59%). Second, even a (relatively small) unmodeled time offset of 10 msec between the IMU and the camera clocks, results in an increase of the loop closure error from 0:59% to 0:91%. In practice, with about 50 msec of an unmodelled time offset, the filter will diverge immediately. Third, by ignoring the rolling shutter effect, the estimation accuracy drops dramatically, since during the readout time of an image (about 30 msec), the cell phone can move even 4.5 cm, which for a scene at 3 meters from the camera, corresponds to a 2 pixel measurement noise. Finally, both the rolling shutter and the time synchronization were ignored in which case the filter diverged immediately.

In the second experiment, estimation was performed online. During the trial, the cell phone traversed a path of 231 meters across two floors of a building, with an average velocity of 1.2 m/sec. This trajectory included both crowded areas and featureless scenes. The final position error was 1.8 meters, corresponding to 0.8% of the total distance travelled (see FIG. 5B).

In order to experimentally validate the computational gains of the proposed method versus existing approaches for online time synchronization and rolling-shutter calibration, which require augmenting the state vector with the velocities of each clone, the QR decomposition of the measurement compression step in the MSC-KF for the two measurement models were compared for the various models. Care was taken to create a representative comparison. The QR decomposition algorithm provided was used by the C++ linear algebra library Eigen, on Samsung S4. The time to perform this QR decomposition was recorded for various numbers of cloned poses, M, observing measurements of 50 features.

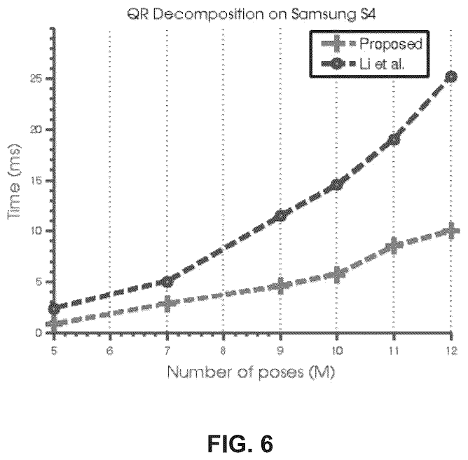

Similar to both algorithms, a Jacobian matrix with 50(2M−3) rows was considered. However, the number of columns differs significantly between the two methods. As expected, based on the computational cost of the QR factorization, O(mn²) for a matrix of size m×n, the proposed method leads to significant computational gains. As demonstrated in FIG. 6, the techniques described herein may utilize a QR factorization that is 3 times faster compared to the one described in Mingyang Li, Byung Hyung Kim, and Anastasios I. Mourikis, Real-time motion tracking on a cellphone using inertial sensing and a rolling-shutter camera, In Proc. of the IEEE International Conference on Robotics and Automation, pages 4697-4704, Karlsruhe, Germany, May 6-10 2013.

Furthermore, since the dimension of the system is reduced to almost half through the proposed interpolation model, all the operations in the EKF update will also gain a significant speedup (i.e., a factor of 4 for the covariance update, and a factor of 2 for the number of Jacobians evaluated). Such speed up on a cell phone, which has very limited processing resources and battery, provides additional benefits, because it both allows other applications to run concurrently, and extends the phone's operating time substantially.

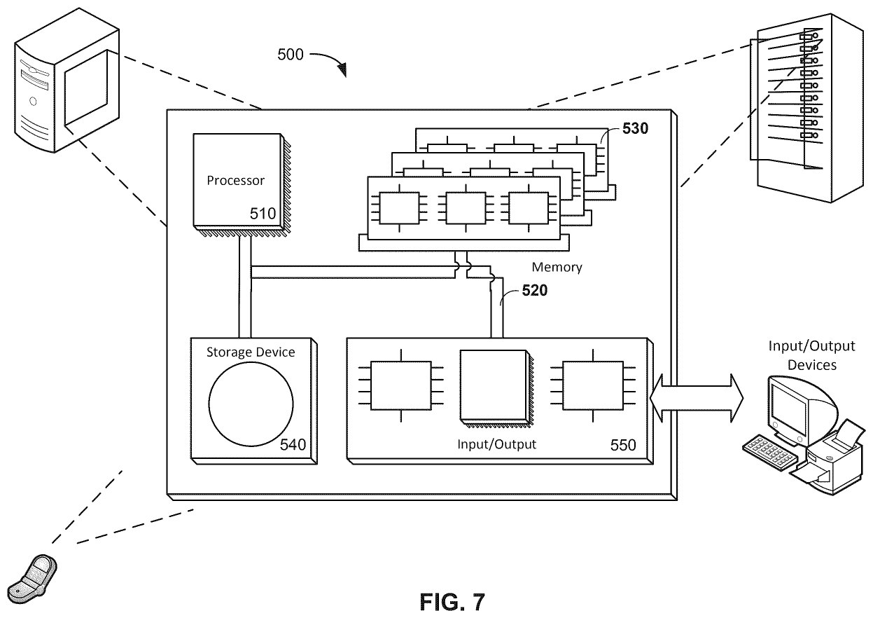

FIG. 7 shows a detailed example of various devices that may be configured as a VINS to implement some embodiments in accordance with the current disclosure. For example, device 500 may be a mobile sensing platform, a mobile phone, a workstation, a computing center, a cluster of servers or other example embodiments of a computing environment, centrally located or distributed, capable of executing the techniques described herein. Any or all of the devices may, for example, implement portions of the techniques described herein for vision-aided inertial navigation system.

In this example, a computer 500 includes a hardware-based processor 510 that is operable to execute program instructions or software, causing the computer to perform various methods or tasks, such as performing the enhanced estimation techniques described herein. Processor 510 may be a general purpose processor, a digital signal processor (DSP), a core processor within an Application Specific Integrated Circuit (ASIC) and the like. Processor 510 is coupled via bus 520 to a memory 530, which is used to store information such as program instructions and other data while the computer is in operation. A storage device 540, such as a hard disk drive, nonvolatile memory, or other non-transient storage device stores information such as program instructions, data files of the multidimensional data and the reduced data set, and other information. As another example, computer 500 may provide an operating environment for execution of one or more virtual machines that, in turn, provide an execution environment for software for implementing the techniques described herein.

The computer also includes various input-output elements 550, including parallel or serial ports, USB, Firewire or IEEE 1394, Ethernet, and other such ports to connect the computer to external device such a printer, video camera, surveillance equipment or the like. Other input-output elements include wireless communication interfaces such as Bluetooth, Wi-Fi, and cellular data networks.

The computer itself may be a traditional personal computer, a rack-mount or business computer or server, or any other type of computerized system. The computer in a further example may include fewer than all elements listed above, such as a thin client or mobile device having only some of the shown elements. In another example, the computer is distributed among multiple computer systems, such as a distributed server that has many computers working together to provide various functions.

The techniques described herein may be implemented in hardware, software, firmware, or any combination thereof. Various features described as modules, units or components may be implemented together in an integrated logic device or separately as discrete but interoperable logic devices or other hardware devices. In some cases, various features of electronic circuitry may be implemented as one or more integrated circuit devices, such as an integrated circuit chip or chipset.

If implemented in hardware, this disclosure may be directed to an apparatus such a processor or an integrated circuit device, such as an integrated circuit chip or chipset. Alternatively or additionally, if implemented in software or firmware, the techniques may be realized at least in part by a computer readable data storage medium comprising instructions that, when executed, cause one or more processors to perform one or more of the methods described above. For example, the computer-readable data storage medium or device may store such instructions for execution by a processor. Any combination of one or more computer-readable medium(s) may be utilized.

A computer-readable storage medium (device) may form part of a computer program product, which may include packaging materials. A computer-readable storage medium (device) may comprise a computer data storage medium such as random access memory (RAM), read-only memory (ROM), non-volatile random access memory (NVRAM), electrically erasable programmable read-only memory (EEPROM), flash memory, magnetic or optical data storage media, and the like. In general, a computer-readable storage medium may be any tangible medium that can contain or store a program for use by or in connection with an instruction execution system, apparatus, or device. Additional examples of computer readable medium include computer-readable storage devices, computer-readable memory, and tangible computer-readable medium. In some examples, an article of manufacture may comprise one or more computer-readable storage media.

In some examples, the computer-readable storage media may comprise non-transitory media. The term “non-transitory” may indicate that the storage medium is not embodied in a carrier wave or a propagated signal. In certain examples, a non-transitory storage medium may store data that can, over time, change (e.g., in RAM or cache).

The code or instructions may be software and/or firmware executed by processing circuitry including one or more processors, such as one or more digital signal processors (DSPs), general purpose microprocessors, application-specific integrated circuits (ASICs), field-programmable gate arrays (FPGAs), or other equivalent integrated or discrete logic circuitry. Accordingly, the term “processor,” as used herein may refer to any of the foregoing structure or any other processing circuitry suitable for implementation of the techniques described herein. In addition, in some aspects, functionality described in this disclosure may be provided within software modules or hardware modules.

Various embodiments of the invention have been described. These and other embodiments are within the scope of the following claims.

1. (canceled)

2. A mobile device comprising:
a rolling shutter camera capable of capturing images at a first set of time instances as the mobile device moves along a trajectory within a three-dimensional (3D) environment, where:
the rolling shutter camera comprises a sensor capable of capturing a plurality of rows of image data row-by-row so that each row is captured at a different time instance than any of the first set of time instances; and
positions in which features from the 3D environment are observed within captured images are impacted by ensemble distortion due to motion of the mobile device along the trajectory;
an inertial measurement unit (IMU) capable of producing IMU data for the mobile device as it moves along the trajectory at a second set of time instances; and
a processor capable of:
maintaining a sliding window of IMU poses based upon the IMU data;
for each captured image, computing estimated poses of the rolling shutter camera during capture of each row of image data of the captured image based upon the IMU poses within the sliding window of IMU poses and assuming that linear velocity and rotational velocity of the mobile device are variable during capture of the plurality of rows of image data of the captured image; and
computing estimated poses for the mobile device based upon reprojections of observed features from the 3D environment into the captured images, where the reprojections utilize the estimated poses for the rolling shutter camera during capture of each of the captured images to account for the ensemble distortion.

3. The mobile device of claim 2, wherein the processor is configured to compute the estimated poses of the rolling shutter camera during capture of each row of image data of the captured image as at least one of:
an extrapolation from the IMU poses within the sliding window of IMU poses that are closest in time along the trajectory; or
an interpolation from the IMU poses within the sliding window of IMU poses that are closest in time along the trajectory.

4. The mobile device of claim 3, wherein:
the processor is configured to compute the estimated poses of the rolling shutter camera during capture of each row of image data of the captured image as the interpolation from the IMU poses within the sliding window of IMU poses that are closest in time along the trajectory; and
the interpolation is a higher-order interpolation.

5. The mobile device of claim 3, wherein, when a given row of the plurality of rows is captured, computing the estimated poses of the rolling shutter camera during capture of each row of image data of the captured image comprises updating a state vector with the estimated poses.

6. The mobile device of claim 5, wherein computing the estimated poses of the rolling shutter camera during capture of each row of image data of the captured image further comprises:
cloning a latest IMU pose; and
adding the latest IMU pose into the state vector as a latest estimated pose of the rolling shutter camera.

7. The mobile device of claim 6, wherein the latest estimated pose of the rolling shutter camera comprises:
a rotational estimate for each of a pitch, a roll, and a yaw; and
a position estimate for each of an x-axis, a y-axis, and a z-axis.

8. The mobile device of claim 7, wherein the latest estimated pose further comprises a time offset scalar that is based, at least in part, on:
a first timepoint, corresponding to the latest IMU pose;
a second timepoint, corresponding to when a first row of the plurality of rows begins to be captured; and
a third timepoint, corresponding to when the given row of the plurality of rows is completely captured.

9. The mobile device of claim 8, wherein the time offset scalar comprises a ratio applied in the interpolation.

10. The mobile device of claim 6, wherein, wherein the latest estimated pose omits a value for velocity of the rolling shutter camera.

11. The mobile device of claim 6, wherein the processor is further configured to:
build a map of the 3D environment based upon information including the state vector; and
navigate the mobile device using the map.

12. A method for estimating a device position, the method comprising:
capturing, using a rolling shutter camera, image data for a first set of time instances along a trajectory within a three-dimensional (3D) environment, wherein:
the rolling shutter camera comprises a sensor capable of capturing a plurality of rows of image data row-by-row so that each row is captured at a different time instance than any of the first set of time instances; and
positions in which features from the 3D environment are observed within captured images are impacted by ensemble distortion due to motion of a mobile device along the trajectory;
receiving, from an inertial measurement unit (IMU), at a processor IMU data for the mobile device as it moves along the trajectory at a second set of time instances;
maintaining, using the processor, a sliding window of IMU poses based upon the IMU data;
for each captured image, computing, using the processor, estimated poses of the rolling shutter camera during capture of each row of image data of the captured image based upon the IMU poses within the sliding window of IMU poses and assuming that linear velocity and rotational velocity of the mobile device are variable during capture of the plurality of rows of image data of the captured image; and
computing, using the processor, estimated poses for the mobile device based upon reprojections of observed features from the 3D environment into the captured images, where the reprojections utilize the estimated poses for the rolling shutter camera during capture of each of the captured images to account for the ensemble distortion.

13. The method of claim 12, wherein computing the estimated poses of the rolling shutter camera during capture of each row of image data of the captured image as at least one of:
an extrapolation from the IMU poses within the sliding window of IMU poses that are closest in time along the trajectory; or
an interpolation from the IMU poses within the sliding window of IMU poses that are closest in time along the trajectory.

14. The method of claim 13, wherein:
the processor is configured to compute the estimated poses of the rolling shutter camera during capture of each row of image data of the captured image as an interpolation from the IMU poses within the sliding window of IMU poses that are closest in time along the trajectory; and
the interpolation is a higher-order interpolation.

15. The method of claim 13, wherein, when a given row of the plurality of rows is captured, computing the estimated poses of the rolling shutter camera during capture of each row of image data of the captured image comprises updating a state vector with the estimated poses.

16. The method of claim 15, wherein computing the estimated poses of the rolling shutter camera during capture of each row of image data of the captured image further comprises:
cloning a latest IMU pose; and
adding the latest IMU pose into the state vector as a latest estimated pose of the rolling shutter camera.

17. The method of claim 16, wherein the latest estimated pose of the rolling shutter camera comprises:
a rotational estimate for each of a pitch, a roll, and a yaw; and
a position estimate for each of an x-axis, a y-axis, and a z-axis.

18. The method of claim 17, wherein the latest estimated pose further comprises a time offset scalar that is based, at least in part, on:
a first timepoint, corresponding to the latest IMU pose;
a second timepoint, corresponding to when a first row of the plurality of rows begins to be captured; and
a third timepoint, corresponding to when the given row of the plurality of rows is completely captured.

19. The method of claim 18, wherein the time offset scalar comprises a ratio applied in the interpolation.

20. The method of claim 16, wherein, wherein the latest estimated pose omits a value for velocity of the rolling shutter camera.

21. The method of claim 15, further comprising:
building a map of the 3D environment based on the state vector; and
navigating the mobile device using the map.
